(19) United States
(12) Patent Application Publication
(10) Pub. No.: US 2023/0223219 A1
(43) Pub. Date: Jul. 13, 2023

(54) HAND-HELD INPUT DEVICE WITH THREE-INPUT SWITCHES

(71) Applicant: Dell Products L.P., Round Rock, TX (US)

(72) Inventors: Jason Scott Morrison, Chadron, NE (US); Emily Holub, Austin, TX (US); Glenn Ross Chiappe, Austin, TX (US); Christopher Santos Bautista, Austin, TX (US)

(73) Assignee: Dell Products L.P., Round Rock, TX (US)

(21) Appl. No.: 17/647,966

(22) Filed: Jan. 13, 2022

(51) Int. Cl. H01H 23/16; H01H 23/24; H01H 23/04; G05G 9/047; G06F 3/0346; G06F 3/0338; G06F 3/03; G06F 3/023

(52) U.S. Cl. CPC H01H 23/16; H01H 23/24; H01H 23/04; G05G 9/047; G06F 3/0346; G06F 3/0338; G06F 3/0304; G06F 3/0233; G05G 2009/04774; A63F 13/24

(57) ABSTRACT

An input device for an information handling system may include a body and a plurality of three-input switches positioned on the body. Each of the plurality of three-input switches includes a first outer portion, pressable to enter a first input, a center portion, pressable to enter a second input, and a second outer portion, pres sable to enter a third input. The first outer portion is adjacent to a first side of the center portion, and the second outer portion is adjacent to a second side of the center portion.

### FIELD OF THE DISCLOSURE

The present disclosure generally relates to information handling systems, and more particularly relates to input devices for information handling systems.

### BACKGROUND

As the value and use of information increase, individuals and businesses seek additional ways to process and store information. One option is an information handling system. An information handling system generally processes, compiles, stores, and/or communicates information or data for business, personal, or other purposes. Because technology and information handling needs may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

Information handling systems may be used in a variety of contexts. For example, personal computers may be used by a user at a desk or on a couch. Gaming consoles and televisions may be used by a user while seated in a chair or while standing. A virtual or augmented reality system may be used by a user while seated or while standing and mobile.

A variety of input devices may be used to enter and manipulate information using information handling systems across a wide variety of usage scenarios. Such input devices may include keyboards, such as QWERTY keyboards, for text input, game controllers for gaming or other input, trackpads, trackballs, and computer mice for cursor control, microphones for voice input, cameras for image and video input, motion controllers for gesture and other motion input, and other input devices. One common pairing of input devices for manipulation of information by users is a computer mouse for cursor control and a keyboard, such as a QWERTY keyboard, for text input. One pitfall of use of a computer mouse with a QWERTY keyboard is that a QWERTY keyboard may require use of both hands of a user for efficient entry and/or manipulation of information. Moving between use of a mouse and a QWERTY keyboard may reduce productivity, increasing an amount of time a user spends inputting and/or manipulating information using an information handling system. Furthermore, use of a QWERTY keyboard may lead to wrist and /or joint pain following extended usage periods. For example, the palm down hand position of a user using a QWERTY keyboard and/or mouse may lead to wrist and joint pain after extended usage periods. Gaming controllers, such as handheld gamepads, may be more ergonomic, and thus may be less likely to cause wrist or joint pain, but may be less useful for text input and/or cursor control purposes than a keyboard and mouse pairing. For example, text input using a gaming controller may be cumbersome and slow.

Shortcomings mentioned here are only representative and are included simply to highlight that a need exists for improved information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

An input device, such as a handheld controller for an information handling system, may include multiple three-input switches to allow for efficient text entry and manipulation by a user of the information handing system. For example, using three-input switches, each switch having three pressable portions, a user may select from among at least three inputs using a single finger. In some embodiments, two input devices, one for each hand of a user, may be used to give a user access to a wide range of alpha-numeric characters. In some embodiments, each pressable portion of a three-input switch may, when pressed, lock out one or more other pressable portions of the three-input switch to prevent a user from pressing multiple portions at the same time. In some embodiments, the switches may be aligned along an axis, such as along a vertical axis, to allow for ergonomic text entry. The three-input switches may be arranged and mapped to characters such that a user's muscle memory from use of a QWERTY keyboard may be used to facilitate rapid typing using the input device(s). The input device may also be hand-held allowing a user to enter text in a variety of use contexts, such as standing in place, moving about a room, sitting at a desk, or sitting on a couch or chair. In addition to three-input switches for text input, the input device may include other means of generation of input for the information handling system, such as an optical sensor for generating mouse input, one or more gyroscopes, such as tri-axial gyroscopes, for generating motion input, and other input sensors, buttons, and input triggers. For example, an input device having the plurality of three-input switches and an optical sensor for generation of mouse input may allow a user to both enter text and control a cursor of an information handling system, such as through generation of mouse input, simultaneously. Thus, an input device having a plurality of three-input switches for text entry may enhance a user experience, increasing an efficiency with which a user may enter and manipulate information using an information handling system.

A hand-held input device may include a body and a plurality of three-input switches positioned on the body. The body of the hand-held device may be shaped to fit in a hand of a user. In some embodiments, for example, the plurality of three-input switches may be positioned on the body to face away from the user when the hand-held input device is held by a user. For example, the plurality of three-input switches may be positioned on the body of the hand-held input device to rest under fingertips of a user when the input device is held by a user. For example, the plurality of three-input switches may be aligned along an axis, such as a vertical axis or an axis at an angle compared to a base of the input device, on the body of the input device. For example, a first switch of the plurality of three-input switches may be positioned a first distance from a base of the device, and a second switch of the plurality of three-input switches may be positioned a second distance from a base of the device. In some embodiments, the plurality of three-input switches may include five three-input switches, allowing for input of 15 different characters using a single input device or 30 different characters using an input device for each hand. A pinky of a user may align with a first three-input switch, a ring finger may align with a second three-input switch, a middle finger may align with a third three-input switch, and a pointer finger may align with either a fourth three-input switch or a fifth three-input switch when the input device is held by a user. For example, a pointer finger may be used to trigger inputs using both the fourth and fifth three-input switches. In some embodiments, characters assigned to inputs of each of the three input switches may correspond to assignment of keys to fingers on a QWERTY keyboard. For example, inputs of a lowest three-input switch that is aligned with a pinky of a user when the input device is held in a right hand of the user may be assigned to the characters “Q”, “A”, and “Z”, mirroring the keys assigned to a right hand pink of a user of a QWERTY keyboard. In some embodiments, the body of the input device may be formed to be grasped in a right hand of a user or a left hand of a user. For example, two input devices with different key inputs assigned to each of the three-input switches may have bodies formed and three-input switches positioned to be grasped in a right hand of a user and a left hand of a user. In some embodiments, one or more input switches may be positioned on a top of the body of the input device for receiving input using a thumb of a user. For example, one or more three-input switches may be positioned on a top of the body to align with a thumb of the user when the input device is held by the user.

Each of the three-input switches may include a first outer portion, pressable to enter a first input, a center portion, pres sable to enter a second input, and a second outer portion, pres sable to enter a third input. The first outer portion may be adjacent to a first side of the center portion and the second outer portion may be adjacent to a second side of the center portion. For example, the first outer portion and the second outer portion may be positioned on opposite sides of the center portion. In some embodiments, the first outer portion, the center portion, and the second outer portion of each of the three-input switches may be horizontally aligned on the body of the input device, such as aligned along an axis perpendicular to an axis along which the plurality of three-input switches is aligned. In some embodiments, the first outer portion of each of the switches may include a first protrusion from a surface of the first outer portion at an end of the first outer portion. For example, the first protrusion may be a protrusion at an end of the first outer portion opposite an end of the first outer portion that is adjacent to the center portion. Likewise the second outer portion of each of the switches may include a second protrusion from a surface of the second outer portion at an end of the second outer portion, such as an end of the second outer portion opposite an end of the second outer portion that is adjacent to the center portion. Such protrusions may enhance a user experience by allowing a user to feel where a finger of the user is on each three-input switch.

In some embodiments, the input device may further include an optical sensor positioned on a base of the input device for sensing movement of the input device across a surface. For example, when the input device is grasped by a user and the base of the input device is rested on a surface, such as a desk, the optical sensor of the input device may sense movement of the input device across the surface. Thus, the input device may be used by the user to simultaneously enter computer mouse input via the optical sensor and text input via the plurality of three-input switches. The input device may also be configured to receive computer mouse input via the optical sensor and text input via the plurality of three input switches. Thus, the input device may allow the user to utilize mouse and keyboard functionality at the same time and/or using the same device.

The input device may further include other input sensors, such as one or more gyroscopic sensors, such as tri-axial gyroscopic sensors, for sensing motion input, microphones for receiving voice or other audio input, optical sensors, and other sensors for receiving user input. In some embodiments, the input device may include a joystick, such as a thumbstick, positioned on a top of the body of the input device. The joystick may be positioned for receiving input via a thumb of a user.

A system for entering text input on an information handling system may include a first handheld controller. The first handheld controller may include a first plurality of three-input switches. Each of the first plurality of three-input switches may include a first outer portion, pressable to enter a first input, a center portion, pressable to enter a second input, and a second outer portion, pres sable to enter a third input. The first outer portion may be adjacent to a first side of the center portion, and the second outer portion may be adjacent to a second side of the center portion, opposite the first side of the center portion. Each of the first, second, and third inputs of each of the first plurality of three-input switches may correspond to input of a different text character. The first handheld controller may be formed to be held in a first hand of a user, such as a right hand of the user.

The system may further include a second handheld controller. The second handheld controller may be formed to be held in a second hand of a user, such as a left hand of the user. The second controller may include a second plurality of three-input switches. Each of the second plurality of three-input switches may include a first outer portion, pres sable to enter a first input, a center portion, pressable to enter a second input, and a second outer portion, pressable to enter a third input. The first outer portion and the second outer portion may be located on opposite sides of the center portion of a three-input switch. For example, the first outer portion may be adjacent to a first side of the center portion, and the second outer portion may be adjacent to a second side of the center portion. The first and second sides of the center portion may be opposite sides of the center portion. Each of the first, second, and third inputs of each of the first plurality of three-input switches may correspond to input of a different text character. For example, the inputs of the second plurality of switches of the second handheld controller may be different from the inputs of the first plurality of switches of the first handheld controller.

A three-input switch, such as a three-input switch for text input using an input device, may include a first outer portion, pres sable to enter a first input, a center portion, pressable to enter a second input, and a second outer portion, pressable to enter a third input. The first outer portion may be adjacent to a first side of the center portion, and the second outer portion may be adjacent to a second side of the center portion. The first side of the center portion and the second side of the center portion may be opposite sides of the center portion. Thus, the first outer portion and the second outer portion may be positioned on opposite sides of the center portion.

The three-input switch may include three pivot points. For example, the first outer portion may include a first pivot point on which the first outer portion pivots when pressed. The center portion may include a second pivot point on which the center portion pivots when pressed. The second outer portion may include a third pivot point on which the second outer portion pivots when pressed.

The three-input switch may include locking functionality, such that when the center portion is pressed the first and second outer portions may not be pressed and when the first or second outer portions are pressed the center may not be pressed. For example, while the first outer portion is pressed, the center portion may be locked to prevent the center portion from being pressed. Likewise, while the second outer portion is pressed, the center portion may also be locked to prevent the center portion from being pressed. While the center portion is pressed, the first and second outer portions may be locked to prevent the first and second outer portions from being pressed. A first button may be located beneath the first outer portion, a second button may be located beneath the center portion, and a third button may be located beneath the second outer portion.

In some embodiments, an information handling system may include a memory and a processor for performing the methods described herein. A computer program product may include a non-transitory computer-readable medium including instructions for causing an information handling system to perform the method described herein.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is perspective view of an example set of hand-held input devices according to some embodiments of the disclosure.

FIG. 2 is a perspective view of a base and front of a hand-held input device according to some embodiments of the disclosure.

FIG. 3 is an example typing layout according to some embodiments of the disclosure.

FIG. 4 is an example input layout of multiple three-input switches of two hand-held input devices according to some embodiments of the disclosure.

FIG. 5 is an example chart of average typing speeds achieved with different input devices according to some embodiments of the disclosure.

FIG. 6 is an example graph of typing speed improvement over time using an input device having a plurality of three-input switches according to some embodiments of the disclosure.

FIG. 7 is an example desk usage environment for a pair of hand-held input devices according to some embodiments of the disclosure.

FIG. 8 is an example virtual or augmented reality usage environment for a pair of hand-held input devices according to some embodiments of the disclosure.

FIG. 9 is an example seated usage environment for a pair of hand-held input devices according to some embodiments of the disclosure.

FIG. 10 is an example perspective view of left and right-handed hand-held input devices according to some embodiments of the disclosure.

FIG. 11 is an example perspective view of a plurality of three-input switches of a hand-held input device according to some embodiments of the disclosure.

FIG. 13 is an example perspective view of an assembly of a plurality of three-input switches for a hand-held input device according to some embodiments of the disclosure.

FIG. 14 is a perspective view of a plurality of example forms for three-input switches according to some embodiments of the disclosure.

FIG. 15A is a perspective view of a three-input switch in a default state according to some embodiments of the disclosure.

FIG. 15B is a perspective view of a three-input switch having a center portion pressed according to some embodiments of the disclosure.

FIG. 15C is a perspective view of a three-input switch having a first outer portion pressed according to some embodiments of the disclosure.

FIG. 15D is a perspective view of a three-input switch having a second outer portion pressed according to some embodiments of the disclosure.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications and with several different types of architectures.

For purposes of this disclosure, an information handling system (IHS) may include any instrumentality or aggregate of instrumentalities operable to compute, determine, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, handheld gaming system, console gaming system, hybrid gaming system, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more virtual or physical buses operable to transmit communications between the various hardware and/or software components.

A variety of input devices may be used to input information into and manipulate information using information handling systems. Such input devices may include hand-held gaming controllers, keyboards, computer mice, trackpads, trackballs, microphones, cameras, and other input devices. One common combination of input devices for use with an information handling system is a keyboard, such as a QWERTY keyboard, for typed text input, and a mouse, for cursor control and manipulation. However, a keyboard may require use of both hands for efficient text entry, and it may be difficult or impossible for a user to both enter text using a keyboard and enter cursor control commands using a computer mouse simultaneously. Furthermore, text entry using a QWERTY keyboard may contribute to wrist and joint pain, and use of a keyboard and mouse may be limited to a desk or laptop computer environment. A hand-held controller with typing functionality may be used in a variety of environments, may be more ergonomic than a keyboard, and may include mouse functionality to allow text and cursor control input without switching between input devices. An example pair 100 of hand-held input devices, such as hand-held controllers, is shown in FIG. 1. A first hand-held input device 104 may be shaped to be held in a left hand, while a second hand-held input device 102 may be shaped to be held in a right hand. The first hand-held input device 104 may include a guard 108 for a left hand of a user to enhance grip of the hand-held input device 104, and the second hand-held input device 102 may include a guard 106 for a right hand of a user to enhance grip of the hand-held input device 102.

The first hand-held input device 104 may include an aperture or hole 114 in a middle of a body of the input device 104 to reduce a weight of the hand-held device and/or enhance a user's grip on the input device 104. Likewise, the second input device 102 may include a similar aperture or hole 116. The input devices 102, 104 may include a base beneath the apertures 114, 116 and a top above the apertures 114, 116. The base of one or both of the input devices 102, 104 may include an optical sensor, trackball, or other sensor for generating cursor control mouse input when the base of the device is moved along a surface. The input devices 102, 104 may include a back, situated between the apertures 114, 116 and connecting the base of each hand-held controller to the top of each hand-held controller. The back of the input devices 102, 104 may be situated between a body of the user and the aperture of the controller when the input devices 102, 104 are held by the user.

The input devices 102, 104 may further include a front on an opposite side of the apertures 114, 116 from the front. The fronts of the input devices 102, 104 may connect the bases of the input devices to the tops of the input devices 102, 104 and may be located an opposite side of the apertures 114, 116 from the backs of the input devices 102, 104 when the input devices 102, 104 are held by a user. The fronts of the input devices 102, 104 may include inputs, such as a plurality of three-input switches 122A-122E of the first input device 104, for input of text when the controllers are held by a user. For example, when the input device 104 is held by a user, fingers of a user, such as a pinky finger, ring finger, middle finger, and pointer finger may align with four of the switches, such as switches 122B-E. The switches 122A-E may be buttons having three input positions, such at each switch 122A-E may be used to input three different text characters. The three-input switches 122A-B may be positioned to allow a user to trigger any of the three inputs of three-input switches 122A-B using a pointer finger of the user's left hand when the input device 104 is held by a user. Thus, if both input devices 102, 104 include five three-input switches on the front portion of the input devices, the user may be able to selectively input 30 characters using such three-input switches. In some embodiments, a front portion of an input device, a back portion of an input device, a top of an input device, and a base of an input device may be comprised in a body the input device. The input devices 102, 104 may communicate with an information handling system via a wired or wireless connection, such as a Bluetooth connection, to provide input data, such as character input data from switches 122A-D, input data from buttons 120A-D, 118A-D, joysticks 110, 112, optical sensors, gyroscopes, microphones, and other sensors to an information handling system.

The input devices 102, 104 may further include buttons and other inputs, such as joysticks, to allow a user to enter input using a user's thumbs. In some embodiments, the tops of the input devices 102, 104 may be positioned at an angle compared to the bases of the input devices 102, 104 to enhance ergonomics of the input devices 102, 104. For example, a front portion of an input device 104 may be greater in height than a back portion of the input device 104. Buttons 120A-D may be used for left hand thumb input, and joystick 112 may also be used for left hand thumb input. Likewise, buttons 118A-D and joystick 110 may be used for right hand thumb input. In some embodiments, thumb inputs may be used to adjust a mapping of three-input switches 122A-E to text input, such as to trigger input of capital letters or numbers using the three-input switches 122A-E. The hand-held input devices 102-104 may include additional sensors and means for a user to generate input, such as gyroscopic sensors, microphones, and other sensors. In some embodiments, both input devices 104, 106 may include gyroscopic sensors, such as tri-axial gyroscopes, while in other embodiments, gyroscopic sensors may only be included in a single input device. Likewise, in some embodiments, both input devices 102, 104 may include optical sensors for receiving computer mouse data, while in other embodiments, an optical sensor may be included in only a single input device. In some embodiments, the input devices 102, 104 may be integrated into a single input device grasped by both hands of a user.

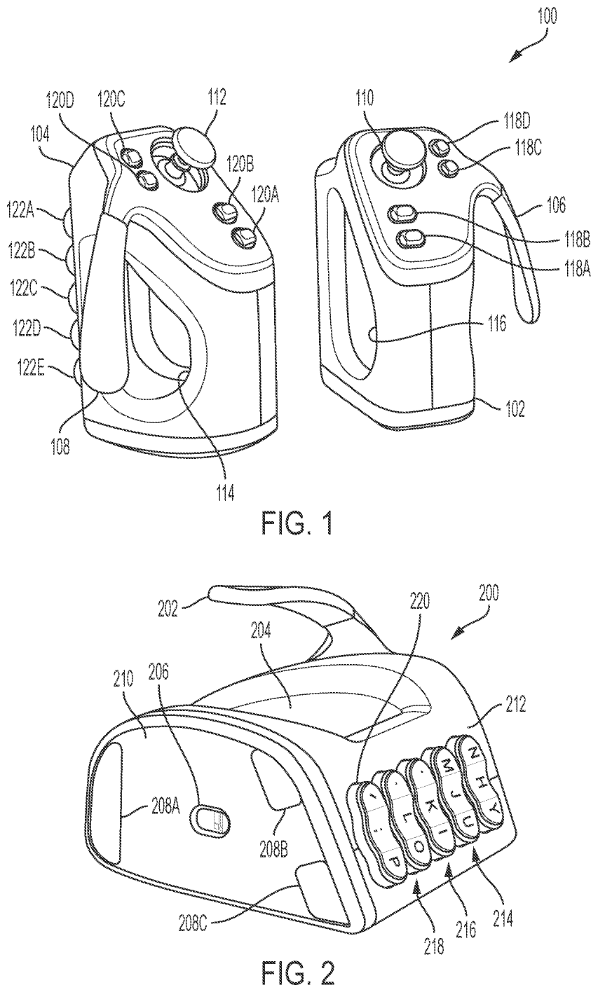

Another view of an example hand-held input device 200 is shown in FIG. 2. The input device 200 may be a right-hand input device, similar to input device 102 of FIG. 1, and may include a hand guard 202 for a right hand of a user. As shown in FIG. 2, the base of input device 200 may include an optical sensor 206 for sensing movement of the input device against a surface. For example, when the input device 200 is grasped by a user, the user may rest the base of the input device 200 on a hard surface, such as a desk. When the user moves the input device 200 across the desk, the optical sensor 206 may sense the movement and may generate computer mouse data, such as cursor control data, based on the movement of the device 200 against the surface. The input device 200 may provide the data generated by the sensor 206 to an information handling system as computer mouse input data. The base of the input device 200 may also include friction-reducing pads 208A-C to reduce friction between the device 200 and the surface. The input device 200 may also include an aperture or hole 204 through the device, similar to device 102 of FIG. 1.

The device 200 may also include a plurality of three input switches 212, 214, 216, 218, and 220. The three-input switches 212-220 may be positioned on the device 200 to rest under fingers of a user, such as under fingertips of a user, when the device 200 is held in a right hand of a user. Each of the switches 212-220 may comprise three inputs, an input entered by pressing a first outer portion, such as a left end of the switch, an input entered by pressing a center portion of the switch, and an input entered by pressing a second outer portion, such as a right end of the switch. The switches 212-220 may be vertically aligned when the controller is held by a user, and the individual inputs of each of the switches may be aligned on an axis parallel to the axis on which the plurality of switches 212-220 is aligned, such as horizontally.

Each input of each of the switches 212-220 may be mapped to a different text character. The switches may be positioned to align with specific fingers of a user when the input device 200 is held by a user. For example, a first switch 220 may be positioned closest to the base of the controller and may be positioned to align with and be activated by a right pinky finger of a user when the input device 200 is held by a user. The inputs of the first switch 220 may be mapped to a slash character, a semicolon character, and a “p” character. A second switch 218 may be positioned to align with and be activated by a right ring finger of the user when the input device 200 is held by the user. The inputs of the second switch 218 may be mapped to a period character, an “l” character, and an “o” character. A third switch 216 may be positioned to align with and be activated by a right middle finger of the user when the input device 200 is held by the user. The inputs of the third switch 216 may be mapped to a comma character, a “k” character, and an “i” character. A fourth input switch 214 and a fifth input switch 212 may be positioned to align with and be selectively activated by a pointer finger of the user when the input device 200 is held by the user. The inputs of the fourth input switch 214 may be mapped to an “m” character, a “j” character, and a “u” character, while the inputs of the fifth input switch 212 may be mapped to an “n” character, an “h” character, and a “y” character. In some embodiments, mapping of inputs of switches 212-220 may be adjustable by a user.

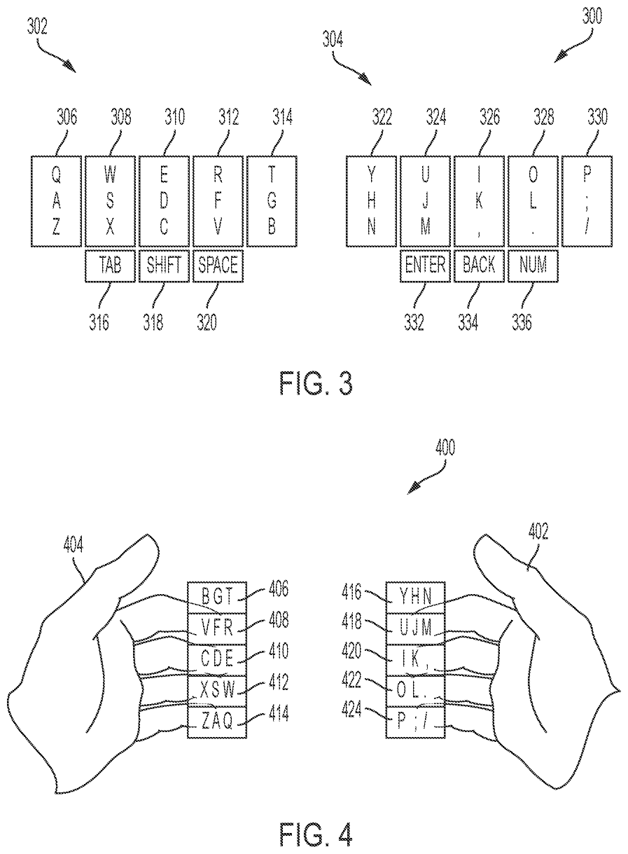

Character mappings of three input switches positioned on a hand-held input device to align with specific fingers of a user may be set to mirror key positioning on a QWERTY keyboard to allow for a user to quickly learn to input text characters using the hand-held input devices. Example mappings 300 as shown in FIG. 3 may include right hand key mappings 302 and left hand key mappings 304. When using a QWERTY keyboard, a pinky finger of a right hand of a user may be used to select “q”, “a”, and “z” keys of a keyboard. Similarly, inputs of a first three-input switch 306 positioned to be triggered by a left-hand pinky of a user may be mapped to “q”, “a”, and “z”, such that a left-hand pinky of a user is used to select the same inputs using the hand-held input controller as using a QWERTY keyboard. Inputs of a second three-input switch 308 positioned to be triggered by a left-hand ring finger of a user may be mapped to “w”, “s”, and “x”, such that a left-hand ring finger of a user is used to select the same inputs using the hand-held input controller as using a QWERTY keyboard. Inputs of a third three-input switch 310 positioned to be triggered by a left-hand middle finger of a user may be mapped to “e”, “d”, and “c”, such that a left-hand ring finger of a user is used to select the same inputs using the hand-held input controller as using a QWERTY keyboard. Inputs of a fourth three-input switch 312 positioned to be triggered by a left-hand pointer finger of a user may be mapped to “r”, “f”, and “v”, such that a left-hand pointer finger of a user is used to select the same inputs using the hand-held input controller as using a QWERTY keyboard. Inputs of a fifth three-input switch 314 positioned to be triggered by a left-hand pointer finger of a user may be mapped to “t”, “g”, and “b”, such that a left-hand pointer finger of a user is used to select the same inputs using the hand-held input controller as using a QWERTY keyboard. A single third three-input switch, or three separate single-input switches may be positioned to be triggered by a thumb of a user to input a tab input 316, a shift input 318, and a space input 320. Thumb inputs may, for example, be positioned on a top of a body of the input device. Inputs of a sixth three-input switch 322 positioned to be triggered by a right-hand pointer finger of a user may be mapped to “y”, “h”, and “n”, such that a right-hand pointer finger of a user is used to select the same inputs using the hand-held input controller as using a QWERTY keyboard. Inputs of a seventh three-input switch 324 positioned to be triggered by a right-hand pointer finger of a user may be mapped to “u”, “j”, and “m”, such that a right-hand pointer finger of a user is used to select the same inputs using the hand-held input controller as using a QWERTY keyboard. Inputs of a eighth three-input switch 326 positioned to be triggered by a right hand middle finger of a user may be mapped to “i”, “k”, and “,”, such that a right hand pointer finger of a user is used to select the same inputs using the hand-held input controller as using a QWERTY keyboard. Inputs of a ninth three-input switch 328 positioned to be triggered by a right-hand ring finger of a user may be mapped to “o”, “r, and “.”, such that a right-hand ring finger of a user is used to select the same inputs using the hand-held input controller as using a QWERTY keyboard. Inputs of a tenth three-input switch 330 positioned to be triggered by a right-hand pinky finger of a user may be mapped to “p”, “;”, and “/”, such that a right-hand pinky finger of a user is used to select the same inputs using the hand-held input controller as using a QWERTY keyboard. A single third three-input switch, or three separate single-input switches may be positioned to be triggered by a right-hand thumb of a user to input a enter input 332, a back input 334, and a num input 336. The switches 306-314 may be vertically aligned on an input device when held by a user, with the switch 306 closest to the base of the input device and the switch 314 closest to the top of the input device. Similarly, the switches 322-330 may be vertically aligned on an input device when held by a user, with the switch 330 closest to the base of the input device and the switch 322 closest to the top of the input device. Thus, the layout of the character-mapped three-input switches 306-314, 322-330 when rotated 90 degrees clockwise, for a right-handed input device, and 90 degrees counterclockwise for a left-handed input device may mirror the key placement of a QWERTY keyboard, as shown in the layout 300 of FIG. 3. Essentially, a key layout of a QWERTY keyboard may be split in half, rotated, and mapped to the three input-switches of right and left-handed input devices as described herein and shown in FIG. 3.

An illustration 400 of three-input switches of right hand and left-hand controllers mapped to characters is shown in FIG. 4. The key mappings of FIG. 4 are shown from a perspective looking through hand-held input devices from a viewpoint of a user. As shown in FIG. 4, a first three-input switch 414 may be positioned on an input device to align with a pinky of a left hand 404 of a user. A second three-input switch 412 may be positioned on an input device to align with a ring finger of a left hand 404 of the user. A third three-input switch 410 may be positioned on an input device to align with a middle finger of a left hand 404 of the user. A fourth three-input switch 408 may be positioned on an input device to align with a pointer finger of a left hand 404 of the user. A fifth three-input switch 406 may be positioned on an input device to align with a pointer finger of a left hand 404 of the user. A sixth three-input switch 416 of the input device, or of a second input device, may be positioned to align with a pointer finger of a right hand 402 of the user. A seventh three-input switch 418 of the input device, or of a second input device, may be positioned to align with a pointer finger of a right hand 402 of the user. An eighth three-input switch 420 of the input device, or of a second input device, may be positioned on the input device to align with a middle finger of a right hand 402 of the user. A ninth three-input switch 422 of the input device, or of a second input device, may be positioned on the input device to align with a ring finger of a right hand 402 of the user. A tenth three-input switch 424 of the input device, or of a second input device, may be positioned on the input device to align with a pinky finger of a right hand 402 of the user. Thus, the input switches 406-424 of the input devices may be aligned vertically on right and left-handed input devices to allow a user to input characters using the switches using muscle memory obtained during use of a QWERTY keyboard.

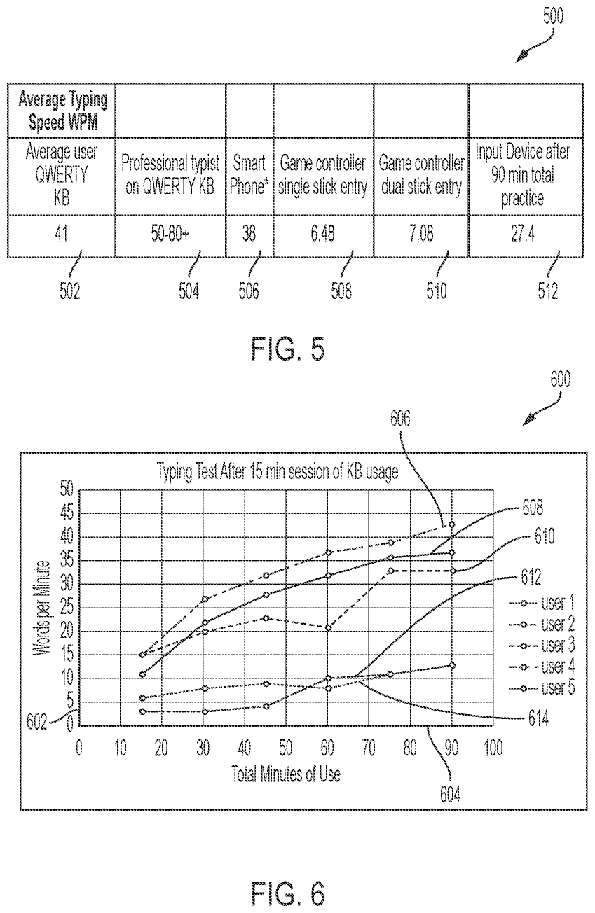

A pair of input devices with a three-input switch layout as described with respect to FIGS. 3 and 4 may facilitate efficient text entry, utilizing muscle memory developed by a user when using a QWERTY keyboard. An example chart 500 shown in FIG. 5 shows average typing speed, in words per minute, for a plurality of users using a variety of different input devices. As a baseline, an average typing speed 502 of an average user using a QWERTY keyboard may be 41 words per minute. A professional typist using a QWERTY keyboard may, for example, achieve an average typing speed 504 of 50-80 or more words per minute. An average typing speed 506 of a user of a smart phone touch keyboard may be 38 words per minute. An average typing speed 508 using a single stick game controller for text entry may be substantially lower, at 6.48 words per minute. An average typing speed 510 using a dual stick game controller for text entry may be slightly higher, at 7.08 words per minute. An average typing speed 512 using an input device as described herein after ninety minutes of practice may be 27.4 words per minute, substantially faster than text entry using a game controller stick entry method.

Use of an input device or pair of input devices described herein for text entry may also be easily learned, with rapid increases in text entry use over time spent using the input device(s). For example, the graph 600 shows an average typing speed in words per minute on a vertical axis 602 plotted against a number of minutes spent using a pair of input devices as described herein on a horizontal axis 604. For a first user 606, an average typing speed using a pair of input devices as described herein may increase from 15 words per minute after 15 minutes of use to 43 words per minute after 90 minutes of use. For a second user 608, an average typing speed using a pair of input devices as described herein may increase from 11 words per minute after 15 minutes of use to 37 words per minute after 90 minutes of use. For a third user 610, an average typing speed using a pair of input devices as described herein may increase from 15 words per minute after 15 minutes of use to 53 words per minute after 90 minutes of use. For a fourth user 612, an average typing speed may increase from 3 words per minute after 15 minutes of use to 11 words per minute after 75 minutes of use. For a fifth user 614, an average typing speed may increase from 6 words per minute after 15 minutes of use to 13 words per minute after 90 minutes of use. Thus, use of a pair of input devices as described herein may be easily learnable, and may allow muscle memory developed by a user who previously used a QWERTY keyboard to be applied to entry of text using the pair of input devices.

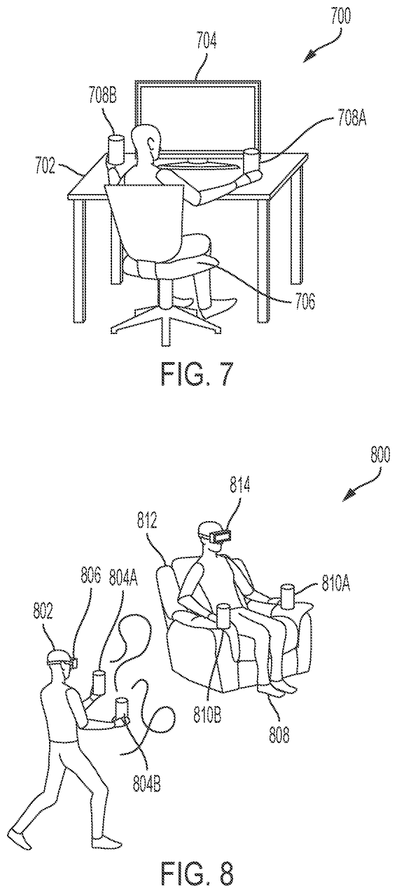

Input devices, as described herein, may be used in a variety of environments. For example, in a desk environment 700, as shown in FIG. 7, a user 706 may, in some cases, use a mouse and keyboard to enter and manipulate data using an information handling system. For example, a user 706 may be seated in a chair or standing at a desk 702 supporting one or more displays 704 of an information handling system. Use of a QWERTY keyboard, in such contexts, may require both hands, and thus a user 706 may be unable to both enter text with a keyboard and manipulate a cursor using a mouse simultaneously. Furthermore, a QWERTY keyboard may have poor ergonomics and extended use of such a keyboard may lead to wrist and joint pain. Use of a pair of input devices 708A-B as described herein in a desk environment 700 may allow a user to enter both mouse input, via an optical sensor in one or both of the input devices 708A-B, and text via three-input switches on the input devices 708A-B. For example, a user may rest the input devices 708A-B on a surface of the desk 702 and may move one or both of the input devices 708A-B along a surface of a desk to enter mouse input, such as cursor control input, using one or more optical sensors positioned on a base of one or both of the hand-held input devices 708A-B. Likewise, the user may enter text using three-input switches positioned on the input devices 708A-B as described herein. In addition to allowing simultaneous mouse input and text input using the same pair of input devices, the positioning of three-input switches on the input devices may be more ergonomic than positioning of keys of a keyboard, and may reduce an amount of wrist and/or joint pain resulting from extended text input sessions. Thus, one environment where hand-held input devices 708A-B having a plurality of three-input switches as described herein may be advantageous is a desk environment 700.

Hand-held input devices, as described herein, may also be useful in a virtual or augmented reality environment 800, as shown in FIG. 8. For example, a user may have difficulty entering text using some virtual or augmented reality controllers, as such controllers may have limited input options and may not have pluralities of vertically aligned three-input switches for text input. For example, some virtual or augmented reality controllers may use pointer functionality for selection of characters for entry using gyroscope data to “point” at a selected character on a keyboard displayed in virtual space. Input devices having a plurality of three-input switches, as described herein, however, may allow for efficient text entry, increasing a speed at which a user is able to enter text in a virtual reality environment. For example, a user 802 wearing a head-mounted display (HMD) 806 may use input devices 804A-B, when standing and moving about a room, such as when using mobile virtual or augmented reality applications. The input devices 804A-B may include one or more gyroscopic sensors, such as tri-axial gyroscopes or accelerometers, to sense user movement of the input devices 804A-B. The input devices 804A-B may further include a plurality of three-input switches to allow for efficient text entry in a virtual or augmented reality environment 800. Such text entry may be more rapid than text entry using motion-controlled point and select functionality. Similarly, a user 808 may be seated, such as in a chair 812, while wearing an HMD 814 in a virtual or augmented reality environment. The user 808 may similarly use input devices 810A-B to enter text and provide other input, such as motion input, to an information handling system in the virtual or augmented reality environment 800. In the virtual or augmented reality environment 800, the input devices 810A-B may provide input information, such as character, motion, and other input information, to the HMD 814 and/or to an external information handling system (not shown). For example, the HMD 814 and the input devices 810A-B may be connected wirelessly, such as via WiFi, Bluetooth, or other wireless means of communication, to an external information handling system. Thus, one environment where hand-held input devices 804A-B, 810A-B having a plurality of three-input switches as described herein may be advantageous is a virtual or augmented reality environment 800.

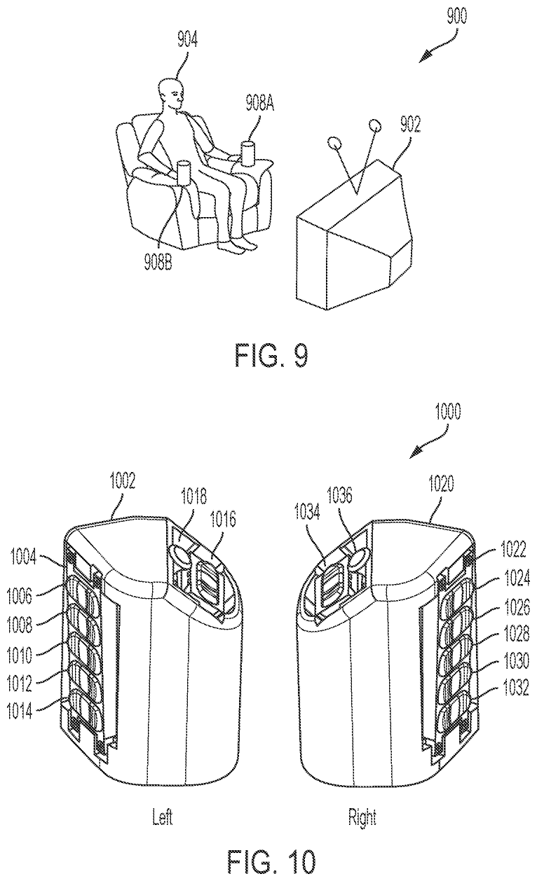

Hand-held input devices having a plurality of three-input switches, as described herein, may also be useful in a television environment 900, as shown in FIG. 9. For example, text entry using a remote control, gamepad, or other controller for a television or television-adjacent device, such as a gaming console or streaming box, may be slow and cumbersome, requiring a user to point and select characters for entry on a television using motion controls, select characters for entry on a television using directional inputs, or select characters for input using other means. A user 904 of an information handling system, such as a television 902 or other information handling system connected to a display or television 902, such as a streaming box or gaming console, may use a set of hand-held input devices 908A-B having a plurality of three-input switches to enter and/or manipulate information using the information handling system. For example, text entry using the information handling system, such as television 902, may be more efficient using the input devices 908A-B having a plurality of three-input switches than using a remote control, gamepad, or other controller. Text entry using the input devices 908A-B, as described herein, may enable more efficient text messaging with other users of other information handling systems, such as when playing online games with other users using the information handling system. Furthermore, input devices 908A-B may provide other input, including other button or joystick input, motion input from one or more gyroscopic sensors or accelerometers of the input devices 908A-B, voice input using one or more microphones of the input devices 908A-B, and other input. Thus, controllers 908A-B having multiple three-input switches may improve a user experience over use of a remote control or gamepad in a television environment 900.

An example perspective view 1000 of a right-handed hand-held input device 1020, such as a hand-held controller, and a left-handed hand-held input device 1002, such as a hand-held controller, is shown in FIG. 10. The input devices 1002, 1020 may include wireless communication modules, such as Bluetooth, WiFi, or cellular communications modules to transmit input information from the devices 1002, 1020 to an information handling system.

A body of the left-handed input device 1002 may be shaped to fit in a hand of a user, with fingertips of a user aligning with three-input switches 1006-1014 when the device 1002 is held by a user. For example, the device 1002 may include a three-input switch assembly 1004 including a plurality of three-input switches 1006-1014. Such an assembly 1004 may be positioned on a front of the device 1002 to face away from the user when the device 1002 is held by a user and may include five three-input switches 1006-1014 positioned to align with fingers of a left hand of a user. Each of the three-input switches 1006-1014 may include first and second outer portions and a center portion, with each portion mapped to a different character input, as described with respect to left-handed switches 306-314 of FIG. 3 and left-handed switches 406-414 of FIG. 4. The left-handed device 1002 may further include an optical sensor in a base (not shown) and one or more gyroscopic sensors, such as tri-axial gyroscopes or accelerometers, for sensing multi-dimensional motion of the device 1002. The device 1002 may further include one or more switches positioned on a top of the controller. For example, an additional three-input switch 1016 may be positioned on a top of the controller. The additional three-input switch 1016 may be positioned to align with a thumb of the user when the device 1002 is held, and the inputs of the three-input switch 1016 may be mapped to inputs such as inputs 316, 318, and 320 of FIG. 3. The device 1002 may further include a joystick 1018 positioned on the top of the device 1002 for control by a thumb of a user. The three-input switches 1006-1014 may be vertically aligned, or otherwise aligned along a first axis. The first and second outer portions and the center portion of each of the three input switches 1006-1014 may be aligned along a horizontal axis, or aligned along a second axis perpendicular to the first axis along which the plurality of three-input switches 1006-1014 is aligned.

A body of the right-handed input device 1020 may be shaped to fit in a right hand of a user, with fingertips of a user aligning with three-input switches 1024-1032 when the device 1020 is held by a user. For example, the device 1020 may include a three-input switch assembly 1022 including a plurality of three-input switches 1024-1032. Such an assembly 1022 may be positioned on a front of the device 1002 to face away from the user when the device 1020 is held by a user and may include five three-input switches 1024-1032 positioned to align with fingers of a right hand of a user. Each of the three-input switches 1024-1032 may include first and second outer portions and a center portion, with each portion mapped to a different character input, as described with respect to right-handed switches 322-330 of FIG. 3 and right-handed switches 416-424 of FIG. 4. The right-handed device 1020 may further include an optical sensor in a base (not shown) and one or more gyroscopic sensors, such as tri-axial gyroscopes or accelerometers, for sensing multi-dimensional motion of the device 1020. The device 1020 may further include an additional three-input switch 1034 positioned on a top of the controller. The additional three-input switch 1034 may be positioned to align with a thumb of the user when the device 1020 is held, and the inputs of the three-input switch 1034 may be mapped to inputs such as inputs 332, 334, and 336 of FIG. 3. The device 1020 may further include a joystick 1036 positioned on the top of the device 1020 for control by a thumb of a user. The three-input switches 1024-1032 may be vertically aligned, or otherwise aligned along a first axis. The first and second outer portions and the center portion of each of the three input switches 1024-1032 may be aligned along a horizontal axis, or aligned along a second axis perpendicular to the first axis along which the plurality of three-input switches 1024-1032 is aligned. All inputs of all three-input switches 1006-1016, 1022-1034 positioned on the input devices 1002, 1020 may be reachable by fingers of a user by adjustment of finger positioning without adjusting positioning of a user's hands. Thus, a first input device 1002, such as a first hand-held controller, and a second input device 1020, such as a second hand-held controller, may each include multiple three-input switches and may be held in right and left hands of a user, respectively, to enter and manipulate information using an information handling system.

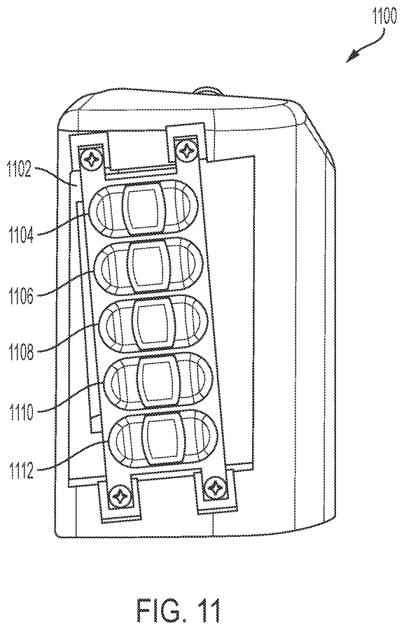

In some embodiments, an assembly 1102 of three-input switches may be positioned at an angle, with respect to a vertical axis of an input device 1100, as shown in FIG. 11. For example, the assembly 1102 may be positioned at an angle, such that the assembly is positioned at an angle with respect to a flat base of the input device 1100. Placement of the assembly 1102, and thus the three-input switches 1104-1112, at an angle with respect to a flat base of the input device 1100 may provide a more ergonomic grip and more ergonomic input selection for a user holding the input device 1100. Thus, a horizontal axis along which the first and second outer portions and the center portion of each of the keys 1104-1112 is aligned may be parallel or not parallel to a flat base of the input device 1100, and an axis along which the plurality of three-input switches 1104-1112 is aligned may be perpendicular or not perpendicular to a flat base of the input device 1100.

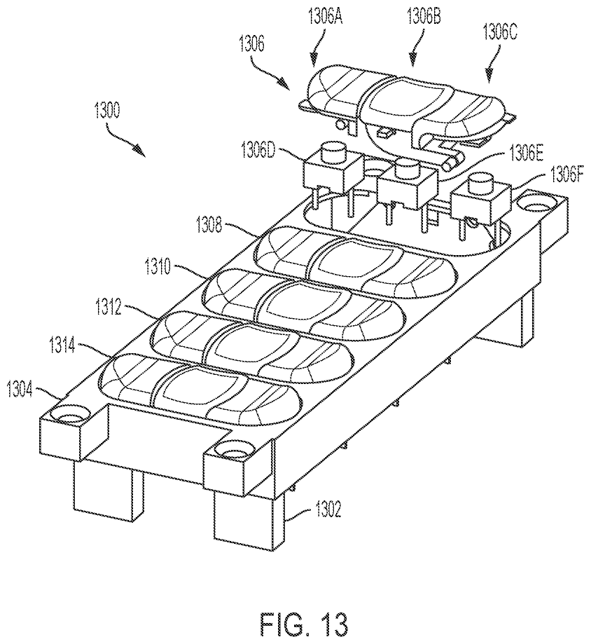

An assembly 1300 of three-input switches for an input device is shown in FIG. 13. Assemblies 1004 and 1022 of FIGS. 10 and 1102 of FIG. 11 may have similar structure and functionality to the structure and functionality described with respect to assembly 1300 of FIG. 13. The assembly 1300 may include a plurality of three-input switches 1306-1314, housed in a housing 1304. A base 1302 may connect the housing 1304 and the switches 1306-1314 to a body of a hand-held input device. A surface portion of a switch, such as a cap of a switch, may include a first outer portion 1306A, a center portion 106B, and a second outer portion 1306C. The first outer portion 1306A, center portion 1306B, and second outer portion 1306C may each be separately pressable by a user to select one of three inputs mapped to the three-input switch. For example, a first character may be mapped to the first outer portion 1306A, a second character may be mapped to the center portion 1306B, and a third character may be mapped to the second outer portion 1306C. The first outer portion 1306A of the three-input switch 1306 may be pressable by a user to enter a first character and, when pressed, may trigger a first push-button switch 1306D, such as a tactile switch, housed beneath the first outer portion 1306A. Likewise, the center portion 1306B of the three-input switch 1306 may be pressable by a user to enter a second character and, when pressed, may trigger a second push-button switch 1306E housed beneath the center portion 1306B. The second outer portion 1306C of the three-input switch 1306 may be pressable by a user to enter a third character and, when pressed, may trigger a third push-button switch 1306F housed beneath the second outer portion 1306C. The push-button switches 1306D-F may be electrically connected to a processor or controller of the hand-held input device and may generate character input information when pressed. The second three-input switch 1308, third three-input switch 1310, fourth three-input switch 1312, and fifth three-input switch 1314 may have similar structures to the first three-input switch 1306. For example, each of the three-input switches 1308-1314 may have a first outer portion, a second outer portion, and a center portion, pressable by a user to enter different character inputs. A user may thus select among the three inputs of a three-input switch 1306 with minimal change in finger positioning.

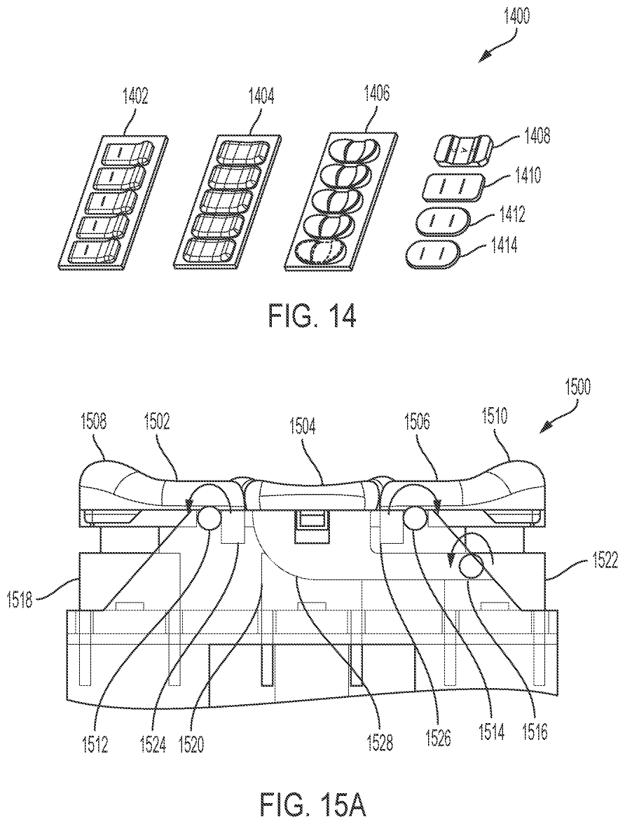

Surfaces of three-input switches may have a variety of structures. An example layout 1400 of a plurality of three-input switch structures is shown in FIG. 14. In a first structure 1402, a plurality of three-input switches may include surfaces with a first raised end on a right side tapering off to a flat end on a left side of each of the switch surfaces. In a second structure 1404, both ends of both outer portions of a three-input switch surface may be raised, with tapering in the center portion of the three-input switch. The switch surfaces of the second structure may be rectangular. In a third example structure 1406, ends of outer portions of a three-input switch surface may be raised and rounded to a semi-circular shape, with the center portion being depressed between the two outer portions and having vertical or diagonal edges connecting the center portion to the first and second outer portions. In a fourth example structure 1408, ends of outer portions of a three-input switch surface may be raised, with a concave center portion located between the two outer portions. In the fourth example structure 1408, characters to which the inputs are mapped may be printed on the three-input switch surface. In a fifth example structure 1410, a three-input switch surface may be flat and rectangular shaped, with raised ridges denoting the divisions between the first and second outer portions and the center portion. In a sixth example structure 1412, a three-input switch surface may be flat and oval shaped, with raised ridges denoting the divisions between the first and second outer portions and the center portion. In a seventh example structure 1414, a three-input switch surface may be flat and oval shaped, with cutout depressions denoting the divisions between the first and second outer portions and the center portion. Thus, three input switches may have a variety of surface forms, that allow a user to determine which portion of the three-input switch the user is pressing without looking at the three-input switches.

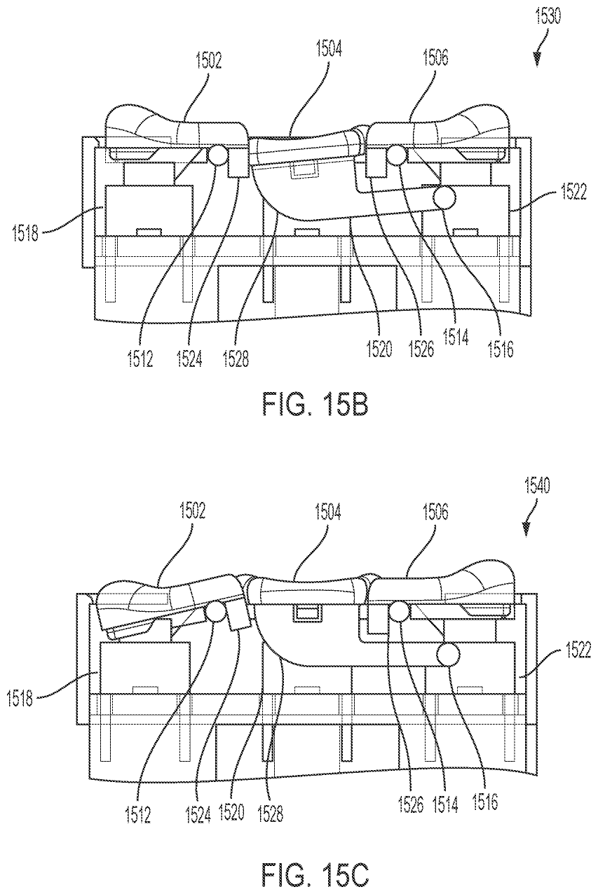

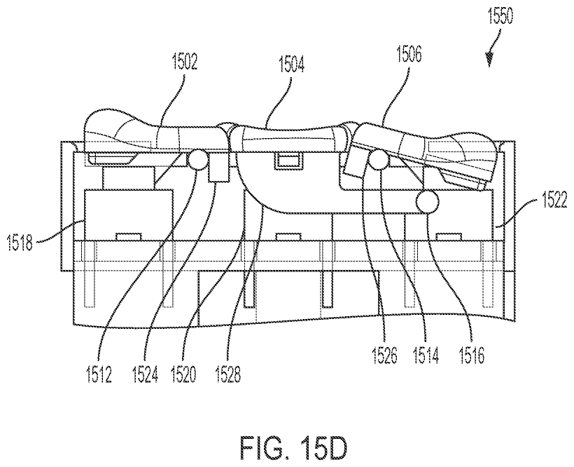

A three-input switch may be structured to allow ease of input of text characters by a user. An example, cross-section of a three-input switch 1500 is shown in FIG. 15A. The three-input switch 1500 is shown in a resting position, with none of the surface portions pressed. The three-input switch 1500 may be structured to provide a user with tactile information as to which portion of the three-input switch the user is pressing. For example, the first outer portion 1502 may include a raised portion 1508, such as a first protrusion, at an end of the first outer portion 1502 opposite an end of the first outer portion adjacent to the center portion 1504. The raised portion 1508 may be raised further outward from a body of an input device in which the three-input switch 1500 is included than the remainder of the first outer portion 1502. Similarly, the center portion 1504 of the three-input switch 1500 may include first and second raised portions at first and second edges of the center portion 1504 adjacent to the first outer portion 1502 and the second outer portion 1506. The raised portions of the center portion 1504 may be less raised than the raised portion 1508 of the first outer portion 1502. The second outer portion 1506 may include a raised portion 1510, such as a second protrusion at an end of the second outer portion 1506 opposite an end of the second outer portion adjacent to the center portion 1504. The raised portion 1510 may be raised further outward from a body of an input device in which the three-input switch 1500 is included than the remainder of the second outer portion 1506. The raised portions of the center portion 1504, the raised portion 1508 of the first outer portion 1502, and the raised portion 1510 of the second outer portion 1506 may enable a user to feel the portion of the three-input switch on which their finger currently rests in order to enter a desired character.

Each of the first outer portion 1502, second outer portion 1506, and center portion 1504 of the three-input switch 1500 may be connected to pivot points about which the portions may pivot. For example, the first outer portion 1502 may be connected to a first pivot point 1512 about which the first outer portion 1502 may pivot when pressed. The pivot 1512 may be located beneath a portion of the first outer portion adjacent to the center portion 1504 to allow an edge of the first outer portion 1502 not adjacent to the center portion 1504 to pivot up and down, about the pivot 1512 when pressed by a user. Thus, when the raised portion 1508 of the first outer portion 1502 is pressed by a user, the first outer portion 1502 may rotate about the pivot 1512 such that the raised portion 1508 moves down with respect to the pivot 1512 while a portion of the first outer portion 1502 directly above the pivot 1512 may remain in a constant position. When the first outer portion 1502 is pressed, it may press and/or trigger a push button switch 1518 located beneath the first outer portion 1502, such as beneath the raised portion 1508 of the first outer portion 1502. Similarly, the second outer portion 1506 may be connected to a second pivot point 1514 about which the second outer portion 1506 may pivot when pressed. The second pivot 1514 may be located beneath a portion of the second outer portion adjacent to the center portion 1504 to allow an edge of the second outer portion 1506 not adjacent to the center portion 1504 to pivot up and down, about the second pivot 1514 when pressed by a user. Thus, when the raised portion 1510 of the second outer portion 1506 is pressed by a user, the second outer portion 1506 may rotate about the second pivot 1514 such that the raised portion 1510 moves down with respect to the pivot 1514 while a portion of the second outer portion 1506 directly above the second pivot 1514 may remain in a constant position. Thus, when the second outer portion 1506 is pressed, it may press and/or trigger a second push button switch 1522 located beneath the second outer portion 1506, such as beneath the raised portion 1510 of the second outer portion 1510. The center portion 1504 of the three-input switch 1500 may be connected to a third pivot point 1516 about which the center portion 1504 may rotate when pressed. The center portion 1504 may, for example, be connected to the third pivot 1516 by an arm 1528 beneath the center portion 1504. For example, the third pivot 1516 may, in some embodiments, be located beneath the second outer portion 1506. Thus, when the center portion 1504 is pressed by a user, then arm 1528 may cause the center portion 1504 to rotate about the pivot 1516. The center portion 1504 may thus, when pressed, press and/or trigger a third push button switch 1520 mapped to a third character. When a user removes pressure from any of the first outer portion 1502, the center portion 1504, or the second outer portion 1506, the portion from which pressure is removed may return to the default position shown in FIG. 15A.

In addition to allowing three inputs, the three-inputs switch 1500 of FIG. 15A may support locking functionality such that pressing a portion of a switch prevents other portions of the switch from being pressed. For example, when a user presses the first outer portion 1502 or the second outer portion 1506 of the switch 1500, the center portion 1504 may be locked to prevent the user from pressing the center portion 1504. Likewise, when a user presses the center portion 1504, the first outer portion 1502 and the second outer portion 1506 may be locked to prevent the user from pressing the first outer portion 1502 and the second outer portion. In some embodiments, pressing an outer portion may lock the unpressed outer portion, in addition to locking the center portion 1504. In some embodiments, locking functionality may be accomplished by locking extensions from the first outer portion 1502 and the second outer portion 1506. For example, as shown in FIG. 15A, a first locking extension 1524 may extend downward from an edge of the first outer portion 1502 adjacent to the center portion 1504. The first locking extension 1524 may, for example, extend downward adjacent to the first pivot 1512. Likewise, a second locking extension 1526 may extend downward from an edge of the second outer portion 1506 adjacent to the center portion 1504.

When a user presses a center portion 1504 of a three-input switch 1530, as shown in FIG. 15B, the first locking extension 1524 and the second locking extension 1526 may prevent the first outer portion 1502 and the second outer portion 1506 from being pressed. For example, as shown in FIG. 15B, the first outer portion 1502 and the first locking extension 1524 may be prevented from rotating about the first pivot 1512 as the first locking portion 1524 may be blocked from rotating about the first pivot 1512 by the depressed center portion 1504. Similarly, the second outer portion 1506 and the second locking extension 1526 may be prevented from rotating about the second pivot 1514 as the second locking portion 1526 may be blocked from rotating about the second pivot 1514 by the depressed center portion 1504.

When a user presses a first outer portion 1502 of a three-input switch 1540, as shown in FIG. 15C, the first locking extension 1524 may prevent the center portion 1504 from being pressed. For example, as shown in FIG. 15C, the center portion 1504 may be prevented from being pressed downward and rotating about the third pivot 1516 as the first locking extension 1524 of the first outer portion 1502 may be raised beneath at least a portion of the center portion 1504, preventing the center portion 1504 from being pressed. In some embodiments, the first locking extension 1524 may be pressed against a base of the center portion 1504 when the first outer portion1502 is pressed, to prevent the center portion from being pressed downward.

When a user presses a second outer portion 1506 of a three-input switch 1550, as shown in FIG. 15D, the second locking extension 1526 may prevent the center portion 1504 from being pressed. For example, as shown in FIG. 15D, the center portion 1504 may be prevented from being pressed downward and rotating about the third pivot 1516 as the second locking extension 1526 of the second outer portion 1506 may be raised beneath at least a portion of the center portion 1504, preventing the center portion 1504 from being pressed. In some embodiments, the second locking extension 1526 may be pressed against a base of the center portion 1504 when the second outer portion 1506 is pressed to prevent the center portion from being pressed downward. In some embodiments the second outer portion 1506 may not be locked when the first outer portion 1502 is pressed, and the first outer portion 1502 may not be locked when the second outer portion 1506 is pressed.

Three-input switches 122A-E of FIG. 1, 212-220 of FIGS. 2, 306-314 and 322-330 of FIG. 3, 406-424 of FIG. 4, 1006-1014 and 1022-1032 of FIG. 10 and 1104-1112 of FIG. 11 may have similar structure and/or functionality to the structure and/or functionality of the three-input switches described with respect to FIGS. 13-15D.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A hand-held input device, comprising:
a body; and
a plurality of three-input switches,
wherein the plurality of three-input switches are positioned on the body,
wherein each of the plurality of three-input switches comprises a first outer portion, pres sable to enter a first input, a center portion, pressable to enter a second input, and a second outer portion, pressable to enter a third input,
wherein the first outer portion is adjacent to a first side of the center portion and the second outer portion is adjacent to a second side of the center portion.

2. The hand-held input device of claim 1, wherein a first switch of the plurality of three-input switches is positioned a first distance from a base of the device, wherein a second switch of the plurality of three-input switches is positioned a second distance from a base of the device, and wherein the first distance is greater than the second distance.

3. The hand-held input device of claim 2, wherein the plurality of three-input switches comprises five three-input switches, wherein four of the plurality of three-input switches are positioned to align with four fingertips of a user when the input device is held by the user.

4. The hand-held input device of claim 1, wherein the body comprises a base, further comprising:
an optical sensor positioned on the base for sensing movement of the input device across a surface, wherein the input device is configured to receive computer mouse input via the optical sensor and text input via the plurality of three-input switches.

5. The hand-held input device of claim 1, further comprising:
one or more gyroscopic sensors for sensing movement of the device along one or more axes.

6. The hand-held input device of claim 1, wherein the body comprises a top, and wherein the input device further comprises a joystick positioned on the top of the body for receiving input via a thumb of a user.

7. The hand-held input device of claim 6, wherein one or more input switches are positioned on the top of the controller.

8. The hand-held input device of claim 1, wherein the first outer portion of each of the three-input switches comprises a first protrusion from a surface of the first outer portion at an end of the first outer portion, and wherein the second outer portion of each of the three-input switches comprises a second protrusion from a surface of the second outer portion at an end of the second outer portion.

9. A system for entering text input on an information handling system, comprising:
a first handheld controller comprising:
a first plurality of three-input switches, wherein each of the first plurality of three-input switches comprises a first outer portion, pres sable to enter a first input, a center portion, pres sable to enter a second input, and a second outer portion, pres sable to enter a third input, wherein each of the first, second, and third inputs of each of the first plurality of three-input switches corresponds to input of a different text character, and wherein the first outer portion is adjacent to a first side of the center portion and the second outer portion is adjacent to a second side of the center portion.

10. The system of claim 9, further comprising:
a second handheld controller comprising:
a second plurality of three-input switches, wherein each of the second plurality of three-input switches comprises a first outer portion, pressable to enter a first input, a center portion, pressable to enter a second input, and a second outer portion, pressable to enter a third input, wherein each of the first, second, and third inputs of each of the second plurality of three-input switches corresponds to input of a different text character, and wherein the first outer portion is adjacent to a first side of the center portion and the second outer portion is adjacent to a second side of the center portion.

11. The system of claim 9, wherein a first switch of the plurality of three-input switches is positioned a first distance from a base of the device, wherein a second switch of the plurality of three-input switches is positioned a second distance from a base of the device, and wherein the first distance is greater than the second distance.

12. The system of claim 11, wherein the first plurality of three-input switches comprises five three-input switches, and wherein four of the three-input switches are positioned to align with four fingertips of a user when the handheld controller is held by the user.

13. The system of claim 11, wherein the first handheld controller further comprises an additional input switch, and wherein the additional input switch is positioned on a top of the handheld controller to align with a thumb of a user when the handheld controller is held by the user.

14. The system of claim 9, wherein the first handheld controller further comprises:
a base of the handheld controller; and
an optical sensor positioned on the base of the handheld controller for sensing movement of the handheld controller across a surface, wherein the handheld controller is configured to receive computer mouse input via the optical sensor.

15. The system of claim 9, wherein the first outer portion of each of the three-input switches comprises a first protrusion from a surface of the first outer portion at an end of the first outer portion, and wherein the second outer portion of each of the three-input switches comprises a second protrusion from a surface of the second outer portion at an end of the second outer portion.

16. A three-input switch, comprising:
a first outer portion, pressable to enter a first input;
a center portion, pressable to enter a second input; and
a second outer portion, pressable to enter a third input,
wherein the first outer portion is adjacent to a first side of the center portion and the second outer portion is adjacent to a second side of the center portion.

17. The three-input switch of claim 16, wherein the first outer portion comprises a first pivot point on which the first outer portion pivots when pressed, wherein the center portion comprises a second pivot point on which the center portion pivots when pressed, and wherein the second outer portion comprises a third pivot point on which the second outer portion pivots when pressed.

18. The three-input switch of claim 16, wherein the first outer portion comprises a first protrusion from a surface of the first outer portion at an end of the first outer portion, and wherein the second outer portion comprises a second protrusion from a surface of the second outer portion at an end of the second outer portion.

19. The three-input switch of claim 16, wherein when the first outer portion is pressed the center portion is locked to prevent the center portion from being pressed, wherein when the center portion is pressed the first outer portion and the second outer portion are locked to prevent the first outer portion and the second outer portion from being pressed, and wherein when the second outer portion is pressed the center portion is locked to prevent the center portion from being pressed.

20. The three-input switch of claim 16, wherein the three-input switch further comprises a first button located beneath the first outer portion, a second button located beneath the center portion, and a third button located beneath the second outer portion.
